(19) United States
(12) Patent Application Publication
(10) Pub. No.: US 2012/0246248 A1
(43) Pub. Date: Sep. 27, 2012

(54) Image Forming Apparatus that Transmits/Receives an Electronic Mail Related to Image Formation, Image Forming Method, and Recording Medium

(75) Inventor: Norie Arita, Osaka (JP)

(73) Assignee: KYOCERA MITA CORPORATION, Osaka (JP)

(21) Appl. No.: 13/429,816

(22) Filed: Mar. 26, 2012

(30) Foreign Application Priority Data
Mar. 24, 2011 (JP) 2011-066765

(51) Int. Cl. G06F 15/16

(52) U.S. Cl. 709/206

(57) ABSTRACT

Provided is an image forming apparatus, including: a communication processing section; a command template transmission section; and a command execution section. The communication processing section transmits/receives an electronic mail related to image formation. The command template transmission section causes the communication processing section to transmit, upon detection of a specific event, a notification electronic mail including a notification of the specific event and a command template of a predetermined command related to the specific event in a text format to a predetermined electronic mail address. The command execution section executes, when a command electronic mail including a command of the same format as the command template in a text format is received by the communication processing section, a process designated by the command included in the command electronic mail.

### INCORPORATION BY REFERENCE

This application is based upon and claims the benefit of priority from the corresponding Japanese Patent application No. 2011-066765, filed Mar. 24, 2011, the entire contents of which is incorporated herein by reference.

### BACKGROUND

The present disclosure relates to an image forming apparatus that transmits/receives an electronic mail related to image formation, an image forming method, and a recording medium.

Some internet facsimile apparatus have a function of receiving an electronic mail. When it is determined that predetermined identification information is included in a subject of the received electronic mail, the subsequent text in the subject is compared with a password registered in advance. When a match occurs therebetween, a body of the electronic mail is recognized as a command, and a setting designated by the command is performed.

However, to transmit a command to the above-mentioned apparatus by electronic mail, a user needs to input the entire command in a text format by using an editor in an electronic mail program. When there are a large number of commands, the user needs to remember all the commands or consult an instruction manual or the like for the commands before inputting the commands in a text format. This, in turn, places a large burden on the user.

### SUMMARY

According to an exemplary embodiment of the present disclosure, there is provided an image forming apparatus that transmits/receives an electronic mail related to image formation, including: a communication processing section; a command template transmission section; and a command execution section. The communication processing section transmits/receives the electronic mail related to the image formation. The command template transmission section causes the communication processing section to transmit, upon detection of a specific event, a notification electronic mail including a notification of the specific event and a command template of a predetermined command related to the specific event in a text format to a predetermined electronic mail address. The command execution section executes, when a command electronic mail including a command of the same format as the command template in a text format is received by the communication processing section, a process designated by the command included in the command electronic mail.

According to an exemplary embodiment of the present disclosure, there is provided an image forming method of transmitting/receiving an electronic mail related to image formation, including: transmitting, upon detection of a specific event, a notification electronic mail including a notification of the specific event and a command template of a predetermined command related to the specific event in a text format to a predetermined electronic mail address; and executing, when a command electronic mail including a command of the same format as the command template in a text format is received by the communication processing section, a process designated by the command included in the command electronic mail.

According to an exemplary embodiment of the present disclosure, there is provided a non-transitory computer readable recording medium that stores an image forming program that causes a computer to function as an image forming apparatus, the image forming program causing the computer to function as: a communication processing section; a command template transmission section; and a command execution section. The communication processing section transmits/receives an electronic mail related to image formation. The command template transmission section causes the communication processing section to transmit, upon detection of a specific event, a notification electronic mail including a notification of the specific event and a command template of a predetermined command related to the specific event in a text format to a predetermined electronic mail address. The command execution section executes, when a command electronic mail including a command of the same format as the command template in a text format is received by the communication processing section, a process designated by the command included in the command electronic mail.

Additional features and advantages are described herein, and will be apparent from the following Detailed Description and the figures.

### BRIEF DESCRIPTION OF THE FIGURES

In the accompanying drawings:

FIG. 1 is a block diagram illustrating a configuration of an image forming system including an image forming apparatus according to an embodiment of the present disclosure;

FIG. 2 is a block diagram illustrating a configuration of the image forming apparatus according to the embodiment of the present disclosure;

FIG. 3 is a flowchart illustrating operations of the image forming apparatus and a user terminal apparatus that are illustrated in FIG. 1;

FIG. 4 is a diagram illustrating an example of a notification electronic mail transmitted by the image forming apparatus illustrated in FIG. 2; and

FIG. 5 is a diagram illustrating an example of a response mail (command electronic mail) to the notification electronic mail illustrated in FIG. 4.

### DETAILED DESCRIPTION

Reference will now be made in detail to various embodiments of the disclosure, one or more examples of which are illustrated in the accompanying drawings. Each example is provided by way of explanation of the disclosure, and by no way limiting the present disclosure. In fact, it will be apparent to those skilled in the art that various modifications, combinations, additions, deletions and variations can be made in the present disclosure without departing from the intended scope or spirit. For instance, features illustrated or described as part of one embodiment can be used in another embodiment to yield a still further embodiment. It is intended that the present disclosure cover such modifications, combinations, additions, deletions, applications and variations that come within the scope of the appended claims and their equivalents.

Hereinafter, an embodiment of the present disclosure is described with reference to the accompanying drawings.

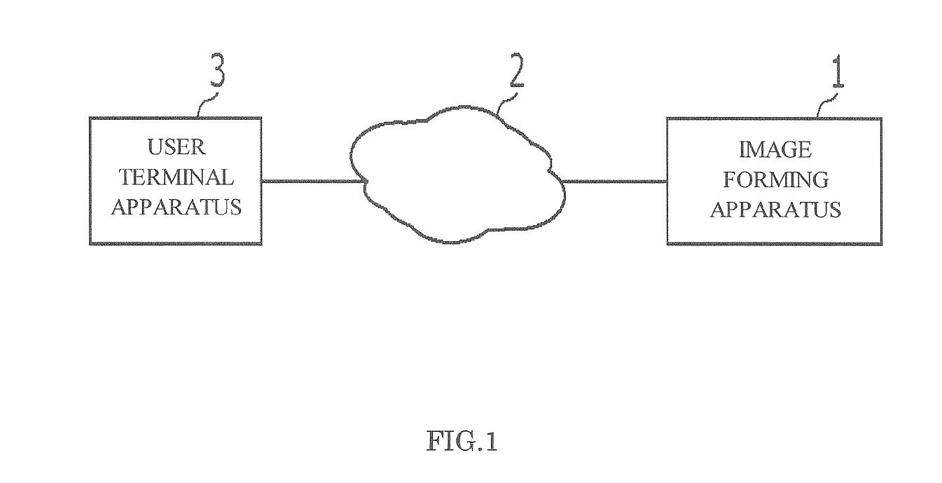

FIG. 1 is a block diagram illustrating a configuration of an image forming system including an image forming apparatus according to this embodiment. In the system illustrated in FIG. 1, an image forming apparatus 1 such as a printer, a copier, a facsimile machine, or a multifunction peripheral is connected through a network 2 to a user terminal apparatus 3. The user terminal apparatus 3 is, for example, a personal computer on which an electronic mail program is installed.

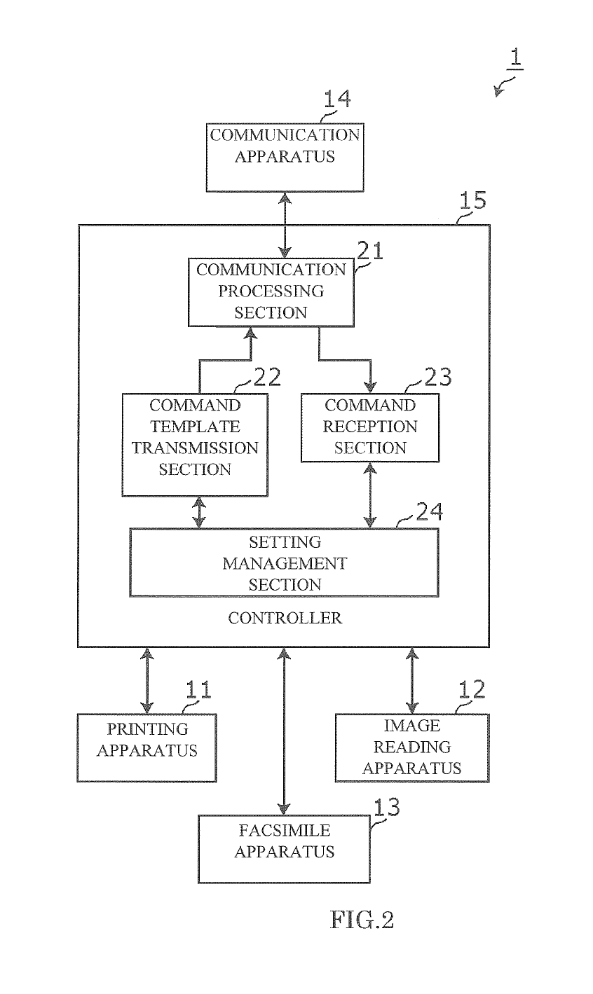

FIG. 2 is a block diagram illustrating a configuration of the image forming apparatus 1 according to this embodiment.

As illustrated in FIG. 2, the image forming apparatus 1 includes a printing apparatus 11, an image reading apparatus 12, a facsimile apparatus 13, a communication apparatus 14, and a controller 15.

The printing apparatus 11 is an internal apparatus that prints images on printing paper, based on printing image data. For example, the printing image data may be generated by an image process such as rasterization or halftoning in response to a printing request (for example, page description language (PDL) data) transmitted from the user terminal apparatus 3. Alternatively, the printing image data may be generated by the image reading apparatus 12 scanning an original image. As another example, the printing image data may be generated from image data based on a facsimile signal received by the facsimile apparatus 13. Other such printing image data also may be used to print the images.

The image reading apparatus 12 is an internal apparatus that generates image data by optically scanning the original image.

The facsimile apparatus 13 is an internal apparatus that, based on the image data, transmits the facsimile signal through a telephone line. In addition, the facsimile apparatus 13 receives the facsimile signal and generates the image data based on the facsimile signal.

The communication apparatus 14 is an apparatus such as a network interface or a modem, which is connected to the network 2 and performs data communications via a predetermined protocol.

The controller 15 is a computer including a central processing unit (CPU), a read only memory (ROM), and a random access memory (RAM), and realizes various processing units by loading programs stored in a storage device (not shown), the ROM, and the like onto the RAM and causes the CPU to execute the programs. In this embodiment, the controller 15 carries out a communication processing section 21, a command template transmission section 22, a command reception section 23, and a setting management section 24.

The communication processing section 21 is a processing section that controls the communication apparatus 14 to perform data communications via a predetermined protocol to/from another apparatus connected to the network 2. In this embodiment, the communication processing section 21 performs transmission/reception of an electronic mail to/from a mail server (not shown) connected to the network 2.

The command template transmission section 22 is a processing section that causes the communication processing section 21 to transmit, upon detection of a specific event, a notification electronic mail including a notification of the specific event and a command template of a predetermined command related to the specific event to a predetermined electronic mail address. This notification electronic mail is preferably in a text format. The destination electronic mail address is, for example, an electronic mail address of a specific user such as an administrator registered in advance on the image forming apparatus 1.

For example, the command template is a template of a command to update a set value for a predetermined setting item, and includes options for a setting value that can be specified.

Further, for example, the command template is a template of a command to update a set value for a predetermined setting item, and includes a format for a setting value that can be specified.

The command reception section 23 is a processing section that detects a command electronic mail from the electronic mail received by the communication processing section 21. From the command electronic mail, the command reception section 23 extracts the command, which is in the same format as the command template (e.g. a text format).

The setting management section 24 manages the setting values for the setting items provided in advance to the respective internal apparatus of the image forming apparatus 1. When the command electronic mail is detected by the command reception section 23, the setting management section 24 executes a setting change designated by the command included in the command electronic mail.

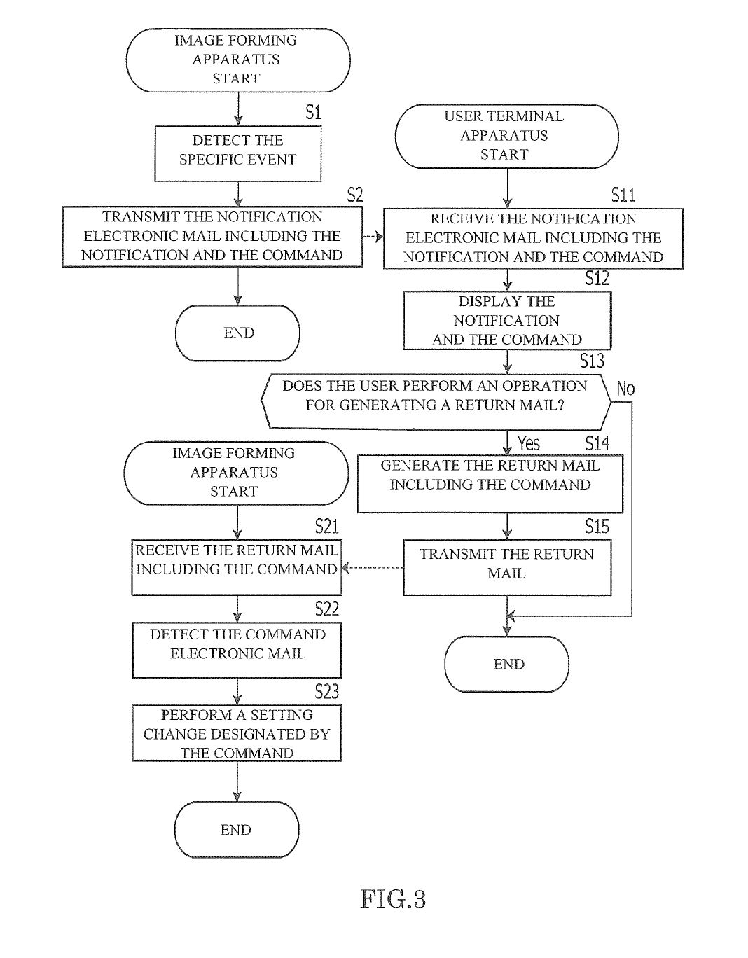

Next described is an operation of the above-mentioned image forming apparatus. FIG. 3 is a flowchart illustrating operations of the image forming apparatus 1 and the user terminal apparatus 3 that are illustrated in FIG. 1.

Upon detecting the specific event (Step S1), the command template transmission section 22 causes the communication processing section 21 to transmit the notification electronic mail including the notification of the specific event and the command template of a predetermined command related to the specific event in a text format to the predetermined electronic mail address (Step S2). Note that, a correlation between the specific event and the command template is previously registered in a database (not shown) or the like, and the command template transmission section 22 refers to the database to identify the command template corresponding to the detected event.

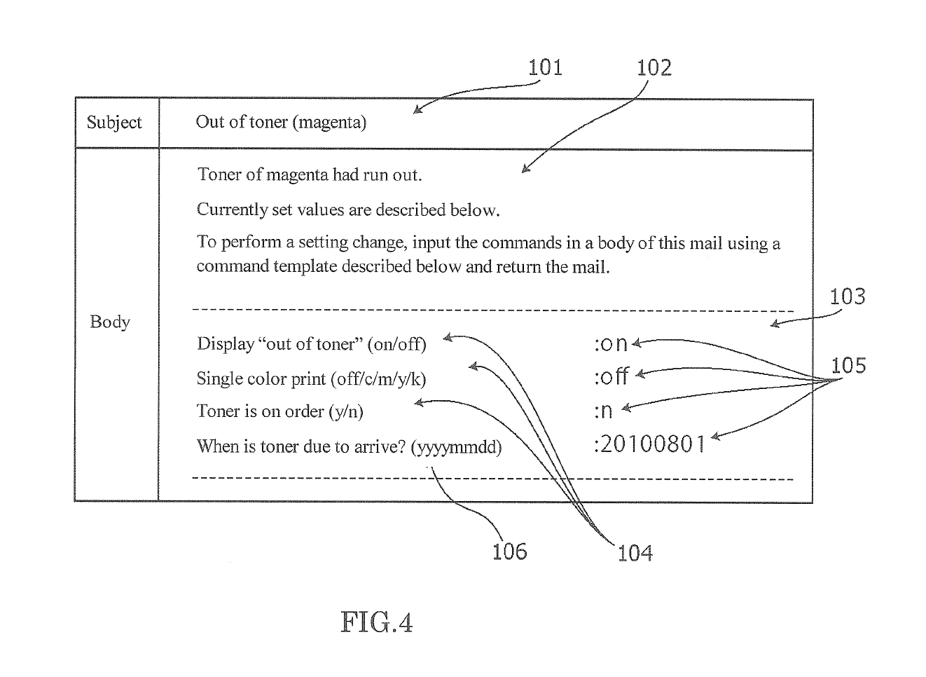

FIG. 4 is a diagram illustrating an example of the notification electronic mail transmitted by the image forming apparatus 1 illustrated in FIG. 2. Specifically, the notification electronic mail illustrated in FIG. 4 is an example of the notification electronic mail transmitted when an event of running out of magenta toner is detected. Note that, the specific event is not limited to the event of running out of toner; other events, such as parts damage or the like, are other examples of events.

In the notification electronic mail, a subject thereof includes a text field 101 of “Out of toner (magenta)” indicating the event, and a body thereof that includes a text field 102 that notifies of the event and a command template 103.

For the example of FIG. 4, the command template includes the templates of a setting command for the setting item “Display ‘out of toner’”, a setting command for the setting item “Single color print”, a setting command for the setting item “Toner is on order”, and a setting command for the setting item “When is toner due to arrive?”.

The template of the setting command for the setting item “Display ‘out of toner’” includes setting values 104 (“on” and “off”) that can be specified with respect to the setting item “Display ‘out of toner’” and a currently set value 105 (“on”). Note that the command template transmission section 22 queries the setting management section 24 to acquire the currently set value.

When the command template 103 includes the setting values 104 as options that can be specified, the user only has to select the setting value to be set by the command from among the options in the notification electronic mail, which can reduce a burden placed on the user when the command is transmitted to the image forming apparatus 1 by electronic mail.

Further, the template of the setting command for the setting item “When is toner due to arrive?” includes a format 106 (“yyyymmdd”) of the setting value that can be specified with respect to the setting item “When is toner due to arrive?”. Note that “yyyymmdd” represents a four-digit year (“y” for “year”), a two-digit month (“m” for “month”), and a two-digit day (“d” for “day).

When the command template 103 includes the format 106 of the setting value that can be specified, the user only has to input the setting value to be set by the command in accordance with the format described in the notification electronic mail, which can reduce the burden placed on the user when the command is transmitted to the image forming apparatus 1 by electronic mail.

The notification electronic mail described above, once transmitted, is received and retained by the mail server that manages the electronic mail address of the specific user. After that, when the user performs a predetermined operation with respect to the user terminal apparatus 3, the user terminal apparatus 3 uses the electronic mail program to download the electronic mail from the mail server. At this time, the notification electronic mail is received by the user terminal apparatus 3 (Step S11). Then, when the user performs a predetermined operation with respect to the user terminal apparatus 3, the user terminal apparatus 3 uses the electronic mail program to display contents of the notification electronic mail (Step S12). This allows the user to view the contents of the notification from the image forming apparatus 1.

When the user determines that the command corresponding to the notification received by the notification electronic mail needs to be transmitted, the user performs an operation for generating a response mail, and when not, the user does not perform an operation for generating a response mail (Step S13).

When such an operation is performed, the user terminal apparatus 3 uses the electronic mail program to generate a response mail in accordance with the operation (Step S14). At this time, the electronic mail program automatically sets a text obtained by adding a prefix of “Re:” to a subject of the notification electronic mail as an initial value (that is, state at the time when a user starts editing) of a subject of the response mail and the text in the body of the notification electronic mail as the initial value (that is, state at the time when the user starts the editing) of the body of the response mail. Then, the command template (part of the currently set value in the template) copied from the notification electronic mail by the electronic mail program is edited in accordance with the user operation, to thereby complete the text of the command. The user can input a desired setting value while viewing the setting values 104 and the format 106 of the setting value.

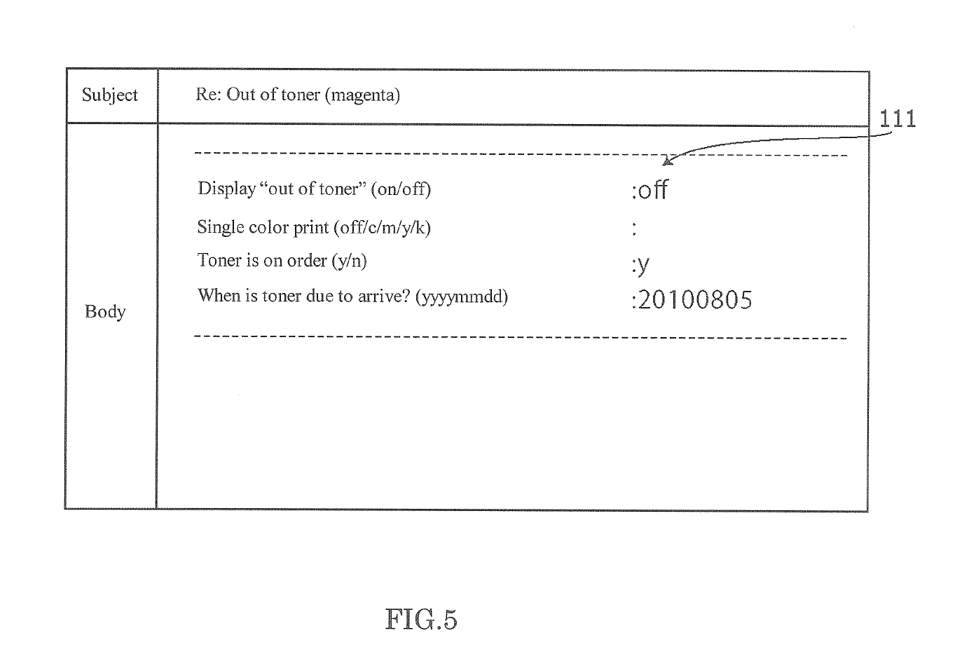

FIG. 5 is a diagram illustrating an example of the response mail (the command electronic mail) to the notification electronic mail illustrated in FIG. 4. As illustrated in FIG. 5, the command generated from the command template in the notification electronic mail illustrated in FIG. 4 is included in the body of the response mail. For example, a command 111 to set the setting value of the setting item “Display ‘out of toner’” to “off” is included. Note that when a field for the currently set value in the command template 103 is left blank (for example, the setting item “Single color print” in FIG. 5), the currently set value is maintained.

The thus-generated response mail is returned by the user terminal apparatus 3 in accordance with the user operation. The response mail is received and retained by the mail server that manages the mail address of the image forming apparatus 1.

The communication processing section 21 of the image forming apparatus 1 periodically queries the mail server about presence/absence of an electronic mail sent to the mail address, and when the response mail is retained by the mail server, downloads the response mail (Step S21).

The response mail received by the communication processing section 21 is the command electronic mail, and hence the command reception section 23 detects the response mail and supplies the response mail to the setting management section 24 (Step S22).

The setting management section 24 interprets the command described in the response mail, and performs a setting change designated by the command (Step S23).

As described above, according to the above-mentioned embodiment, when the specific event is detected, the command template transmission section 22 causes the communication processing section 21 to transmit the notification electronic mail including the notification of the specific event and the command template of the predetermined command related to the specific event in a text format to the predetermined electronic mail address. When the command electronic mail including the command of the same format as the command template in a text format is received by the communication processing section 21, the setting management section 24 executes a command included in the command electronic mail. Executing the command may include executing a process designated by the command.

This enables the user to know how to describe the related command in the notification electronic mail, which eliminates the need to remember how to describe the command or consult an instruction manual or the like. This can reduce the burden placed on the user when the command is transmitted to the image forming apparatus 1 by electronic mail.

Note that the above-mentioned embodiment is merely an example of the present disclosure, and the present disclosure is not limited thereto. Various modifications and changes can be made without departing from the gist of the present disclosure.

For example, in the above-mentioned embodiment, the setting management section 24 may execute the process designated by the command included in the command electronic mail when a subject of the command electronic mail includes a predetermined text (for example, “Out of toner (magenta)” in the notification electronic mail illustrated in FIG. 4) included in the subject of the notification electronic mail and may be inhibited from executing the processing designated by the command included in the command electronic mail when the subject of the command electronic mail does not include the predetermined text included in the subject of the notification electronic mail.

Further, in the above-mentioned embodiment, the command electronic mail may be the response mail to the notification electronic mail and the command template transmission section 22 may embed predetermined identification information in the notification electronic mail. With such a configuration, the setting management section 24 may execute the process designated by the command included in the command electronic mail when the predetermined identification information is included in the command electronic mail and may be inhibited from executing the process designated by the command included in the command electronic mail when the command electronic mail does not include the predetermined identification information. The identification information may differ depending on the notification electronic mail.

This can limit execution of the process designated by the command included in the received command electronic mail to only when the command electronic mail is received from the specific user (for example, administrator) that receives the notification electronic mail.

Further, in the above-mentioned embodiment, the command template transmission section 22 may inhibit the communication processing section 21 from transmitting the notification electronic mail including the same command template as the command template included in the notification electronic mail until the communication processing section 21 receives the command electronic mail corresponding to the notification electronic mail after transmission of the notification electronic mail.

Further, in the above-mentioned embodiment, when a transmission source electronic mail address of the command electronic mail is other than the destination of the corresponding notification electronic mail, the setting management section 24 may control the command reception section 23 so as not to execute the process designated by the command in the command electronic mail. Further, when the process is not to be executed, the electronic mail including a message notifying a person who has transmitted the command electronic mail that the process is not to be executed may be transmitted to the electronic mail address of the transmission source of the command electronic mail.

Further, in the above-mentioned embodiment, the command to change the setting value is taken as an example of the command, but a command to cause the image forming apparatus 1 to perform another operation may be employed.

The invention is claimed as follows:

1. An image forming apparatus that transmits/receives an electronic mail related to image formation, comprising:
a communication processing section that transmits/receives the electronic mail related to the image formation;
a command template transmission section that causes the communication processing section to transmit, upon detection of a specific event, a notification electronic mail including a notification of the specific event and a command template of a predetermined command related to the specific event in a text format to a predetermined electronic mail address; and
a command execution section that executes, when a command electronic mail including a command of the same format as the command template in a text format is received by the communication processing section, a process designated by the command included in the command electronic mail.

2. The image forming apparatus according to claim 1, wherein the command template is a template of a command to update a set value for a predetermined setting item, and includes options for a setting value that can be specified.

3. The image forming apparatus according to claim 1, wherein the command template is a template of a command to update a set value for a predetermined setting item, and includes a format for a setting value that can be specified.

4. The image forming apparatus according to claim 1, wherein the command execution section executes the process designated by the command included in the command electronic mail when a subject of the command electronic mail includes a predetermined text included in a subject of the notification electronic mail and is inhibited from executing the process designated by the command included in the command electronic mail when the subject of the command electronic mail does not include the predetermined text included in the subject of the notification electronic mail.

5. The image forming apparatus according to claim 1, wherein:
the command electronic mail is a response mail to the notification electronic mail;
the command template transmission section embeds predetermined identification information in the notification electronic mail; and
the command execution section executes the process designated by the command included in the command electronic mail when the command electronic mail includes the predetermined identification information and is inhibited from executing the process designated by the command included in the command electronic mail when the command electronic mail does not include the predetermined identification information.

6. The image forming apparatus according to claim 5, wherein the command template transmission section embeds the predetermined identification information, which differs depending on the notification electronic mail, in the notification electronic mail.

7. The image forming apparatus according to claim 1, wherein the command template transmission section inhibits the communication processing section from transmitting the notification electronic mail including the same command template as the command template included in the transmitted notification electronic mail until the communication processing section receives the command electronic mail corresponding to the transmitted notification electronic mail after transmission of the notification electronic mail.

8. The image forming apparatus according to claim 1, wherein, when the communication processing section receives the command electronic mail corresponding to the transmitted notification electronic mail after transmission of the notification electronic mail, the command execution section is inhibited from executing the process designated by the command included in the received command electronic mail when a transmission source electronic mail address of the received command electronic mail is not a destination of the transmitted notification electronic mail.

9. The image forming apparatus according to claim 8, wherein, when the communication processing section receives the command electronic mail corresponding to the transmitted notification electronic mail after the transmission of the notification electronic mail, the communication processing section transmits the electronic mail including a message notifying that the process designated by the command included in the received command electronic mail is not to be executed to the transmission source electronic mail address of the received command electronic mail when the transmission source electronic mail address of the received command electronic mail is not the destination of the transmitted notification electronic mail.

10. An image forming method of transmitting/receiving an electronic mail related to image formation, comprising:
transmitting, upon detection of a specific event, a notification electronic mail including a notification of the specific event and a command template of a predetermined command related to the specific event in a text format to a predetermined electronic mail address; and
executing, when a command electronic mail including a command of the same format as the command template in a text format is received, a process designated by the command included in the command electronic mail.

11. The image forming method according to claim 10, wherein the command template is a template of a command to update a set value for a predetermined setting item, and includes options for a setting value that can be specified.

12. The image forming method according to claim 10, wherein the command template is a template of a command to update a set value for a predetermined setting item, and includes a format for a setting value that can be specified.

13. The image forming method according to claim 10, wherein the executing includes executing the process designated by the command included in the command electronic mail when a subject of the command electronic mail includes a predetermined text included in a subject of the notification electronic mail and inhibiting from executing the process designated by the command included in the command electronic mail when the subject of the command electronic mail does not include the predetermined text included in the subject of the notification electronic mail.

14. The image forming method according to claim 10, wherein the command electronic mail is a response mail to the notification electronic mail, the transmitting includes embedding predetermined identification information in the notification electronic mail, and the executing includes executing the process designated by the command included in the command electronic mail when the command electronic mail includes the predetermined identification information and inhibiting from executing the process designated by the command included in the command electronic mail when the command electronic mail does not include the predetermined identification information.

15. A non-transitory computer readable recording medium that stores an image forming program that causes a computer to function as an image forming apparatus, the image forming program causing the computer to function as:
a communication processing section that transmits/receives an electronic mail related to image formation;
a command template transmission section that causes the communication processing section to transmit, upon detection of a specific event, a notification electronic mail including a notification of the specific event and a command template of a predetermined command related to the specific event in a text format to a predetermined electronic mail address; and
a command execution section that executes, when a command electronic mail including a command of the same format as the command template in a text format is received by the communication processing section, a process designated by the command included in the command electronic mail.

16. The non-transitory computer readable recording medium according to claim 15, wherein the command template is a template of a command to update a set value for a predetermined setting item, and includes options for a setting value that can be specified.

17. The non-transitory computer readable recording medium according to claim 15, wherein the command template is a template of a command to update a set value for a predetermined setting item, and includes a format for a setting value that can be specified.

18. The non-transitory computer readable recording medium according to claim 15, wherein the command execution section executes the process designated by the command included in the command electronic mail when a subject of the command electronic mail includes a predetermined text included in a subject of the notification electronic mail and inhibits from executing the process designated by the command included in the command electronic mail when the subject of the command electronic mail does not include the predetermined text included in the subject of the notification electronic mail.

19. The non-transitory computer readable recording medium according to claim 15, wherein:
the command electronic mail is a response mail to the notification electronic mail;
the command template transmission section embeds predetermined identification information in the notification electronic mail; and
the command execution section executes the process designated by the command included in the command electronic mail when the command electronic mail includes the predetermined identification information and inhibiting from executing the process designated by the command included in the command electronic mail when the command electronic mail does not include the predetermined identification information.
